(19) United States
(12) Patent Application Publication
(10) Pub. No.: US 2019/0258805 A1
(43) Pub. Date: Aug. 22, 2019

(54) COMPUTER-IMPLEMENTED METHOD AND DATA PROCESSING SYSTEM FOR TESTING DEVICE SECURITY

(71) Applicants: Singapore University of Technology and Design, Singapore (SG); BGN Technologies Ltd., Beer-Sheva (IL)

(72) Inventors: Yuval Elovici, Beer-Sheva (IL); Nils Ole Tippenhauer, Singapore (SG); Shachar Siboni, Beer-Sheva (IL); Asaf Shabtai, Beer-Sheva (IL)

(21) Appl. No.: 16/347,493

(22) PCT Filed: Nov. 2, 2017
(86) PCT No.: PCT/SG2017/050552

§ 371 Date: May 3, 2019

(30) Foreign Application Priority Data
Nov. 4, 2016 (SG) 10201609252U

(51) Int. Cl. G06F 21/57; G06F 21/56; G06F 11/26

(52) U.S. Cl. CPC G06F 21/577; G06F 2221/034; G06F 11/261; G06F 21/567

(57) ABSTRACT

A computer-implemented method and a data processing system for testing device security are provided. The method includes executing on one or more processors the steps of: receiving a configuration file; executing a plurality of security tests on a device based on the configuration file received; identifying a suspected application on the device from the security tests; simulating a test condition to trigger an attack on the device by the suspected application; monitoring a behaviour of the device under the simulated test condition; and performing a forensic data analysis on the behaviour of the device under the simulated test condition.

### CROSS REFERENCES TO RELATED APPLICATIONS

This application is a national-stage entry under 35 U.S.C. § 371 of International Application Serial No. PCT/SG2017/050552, filed Nov. 2, 2017, which claims the benefit of priority to Singapore Application No. SG10201609252U, filed Nov. 4, 2016.

### TECHNICAL FIELD

The present invention relates to device security and more particularly to a computer-implemented method and a data processing system for testing device security.

### BACKGROUND

Wearable computing is an emerging, ubiquitous technology in the Internet of Things (IoT) ecosystem, where wearable devices, such as activity trackers, smartwatches, smart glasses, and more, define a new Wearable IoT (WIoT) segment as a user-centered environment. However, the extensive benefits and application possibilities provided by wearable computing are accompanied by major potential compromises in data privacy and security, since any smart wearable device becomes a security risk. In addition, analyzing the security of such devices is a complex task due to their heterogeneous nature and the fact that these devices are used in a variety of contexts.

There is therefore a need to develop advanced mechanisms that, on the one hand, can determine if a wearable device complies with a set of predefined security requirements and, on the other hand, can determine if the device is compromised by malicious applications.

### SUMMARY

Accordingly, in a first aspect, the present invention provides a computer-implemented method for testing device security. The method includes executing on one or more processors the steps of: receiving a configuration file; executing a plurality of security tests on a device based on the configuration file received; identifying a suspected application on the device from the security tests; simulating a test condition to trigger an attack on the device by the suspected application; monitoring a behaviour of the device under the simulated test condition; and performing a forensic data analysis on the behaviour of the device under the simulated test condition.

In a second aspect, the present invention provides a data processing system for testing device security including one or more processors configured to perform the steps of the computer-implemented method according to the first aspect.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic block diagram illustrating a functional architectural model of a data processing system for testing device security in accordance with one embodiment of the present invention;

FIG. 2 is a schematic flow diagram illustrating a computer-implemented method for testing device security in accordance with one embodiment of the present invention;

FIG. 3 is a schematic block diagram illustrating a computer system suitable for implementing the data processing system and the computer-implemented method disclosed herein;

FIG. 4A is a photograph showing a “malicious” application running on a Sony smartwatch device;

FIG. 4B is a photograph showing a network mapping attack being executed on the Sony smartwatch device once a location for the attack is identified when Wi-Fi is enabled on the device;

FIG. 5 is a screenshot of a U-Blox application showing a recorded path around campus supplied by GPS;

FIGS. 6A through 6F are graphs showing the results obtained from the experimental testing process including the internal status of the WIoT-DUTs based on CPU utilization (user and system perspectives in percentages) and memory consumption (in kB, from the free RAM point of view): (A) Sony smartwatch CPU utilization; (B) Sony smartwatch memory consumption; (C) ZGPAX smartwatch-phone CPU utilization; (D) ZGPAX smartwatch-phone memory consumption; (E) Communication monitoring recorded during the testing process; and (F) Correlation in the time dimension between the communication and WIoT-DUTs anomalies;

FIG. 7A is a screenshot of network traces of a pcap file for one of the anomalies identified during the forensic analysis of the Sony device; and

FIG. 7B are partial screenshots illustrating a fake access point attack in the testbed environment.

### DETAILED DESCRIPTION

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

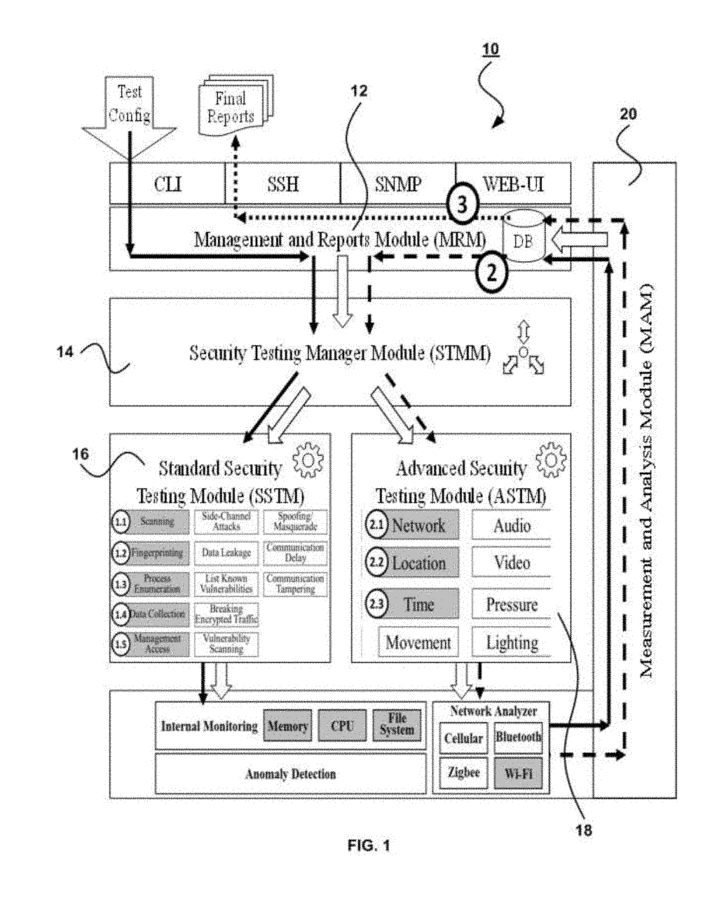

Referring now to FIG. 1, a functional architectural model of a data processing system or security testbed 10 for testing device security is shown. The functional architectural model of the security testbed 10 may be a layer-based platform model with a modular structure. This means that any type of wearable device may be tested in the proposed security testbed framework, and also that any relevant simulator and/or measurement and analysis tool may be deployed in the testbed. In the embodiment shown, the functional architectural model of the data processing system or security testbed 10 includes a Management and Reports Module (MRM) 12, a Security Testing Manager Module (STMM) 14, a Standard Security Testing Module (SSTM) 16, an Advanced Security Testing Module (ASTM) 18 and a Measurements and Analysis Module (MAM) 20.

The Management and Reports Module (MRM) 12 is responsible for a set of management and control actions, including starting the test, enrolling new devices, simulators, tests, measurement and analysis tools and communication channels, and generating the final reports upon completion of the test. The testbed operator (the user) interfaces with the testbed 10 through this module using one of the communication interfaces (Command Line Interface (CLI)\Secure Shell (SSH)\Simple Network management Protocol (SNMP)\Web User Interface (WEB-UI)) in order to initiate the test, as well as to receive the final reports. Accordingly, the Management and Reports Module (MRM) 12 interacts with the Security Testing Manager Module (STMM) 14 and the Measurements and Analysis Module (MAM) 20, respectively. The Management and Reports Module (MRM) 12 holds a system database component that stores all relevant information about the tested device (including the operating system (OS), connectivity, sensor capabilities, advanced features, etc.), as well as stores information regarding the test itself (including configuration files, system snapshots, and test results).

The Security Testing Manager Module (STMM) 14 is responsible for the actual testing sequence executed by the security testbed 10 (possibly according to regulatory specifications). Accordingly, the Security Testing Manager Module (STMM) 14 interacts with the operational testing modules, that is, the Standard and Advanced Security Testing Modules 16 and 18, in order to execute the required set of tests, in the right order, based on predefined configurations provided by the user via the Management and Reports Module (MRM) 12.

The Standard Security Testing Module (SSTM) 16 performs security testing based on vulnerability assessment and penetration test methodology, in order to assess the security level of the Wearable Internet of Things-Device under Test (WIoT-DUT). The Standard Security Testing Module (SSTM) 16 is an operational module which executes a set of security tests as plugins, each of which performs a specific task in the testing process. The Standard Security Testing Module (SSTM) 16 interacts with the Measurements and Analysis Module (MAM) 20 in order to monitor and analyze the test performed. A list of tests that may be performed by the Standard Security Testing Module (SSTM) 16 is shown in Table 1 below.

TABLE 1

| Test | Description | Test/Success criteria (example) |
|---|---|---|
| Scanning (e.g., | Investigate detectability of | Undetectable - WIoT-DUT |
| IP and port | wearable IoT devices by | cannot be detected by testbed |
| scanning) | observing wireless/wired | via any communication channel; |
| | communication channels. | Safe - WIoT-DUT is detectable, |
| | Attempt to identify existence of | but no open ports were |
| | the device. Enumerate | observed; |
| | communication channels/traffic | Minor risk - WIoT-DUT is |
| | types observed, open ports, etc. | detectable, and common ports |
| | | are open, e.g., port 80 (HTTP), |
| | | 443 (HTTPS), etc.; |
| | | Major risk - WIoT-DUT is |
| | | detectable, and uncommon |
| | | ports for such devices are open, |
| | | e.g., ports 20, 21 (FTP), port 22 |
| | | (SSH), port 23 (Telnet), etc.; or, |
| | | Critical risk - WIoT-DUT is |
| | | detectable, and unexpected |
| | | ports are open in the device. |
| Fingerprinting | By monitoring communication | Unidentifiable - type of WIoT- |
| | traffic to/from the device, attempt | DUT cannot be identified by |
| | to identify type of device, its | testbed; |
| | operating system, software | Safe - device provides |
| | version, list of all sensors | identifiable information, but all |
| | supported, etc. | WIoT-DUT's software versions |
| | | are up-to-date; |
| | | Minor risk - some low risk |
| | | detected applications, e.g., |
| | | calendar, etc., are out-of-date; |
| | | Major risk - some major risk |
| | | detected applications, e.g., |
| | | navigator, mail, etc., are out-of- |
| | | date; or, |
| | | Critical risk - operating system |
| | | and critical applications are out- |
| | | of-date. |
| Process | Lists all running processes on | Safe - list of processes cannot |
| enumeration | device and presents their CPU | be extracted without admin |
| | and memory consumptions. This | privileges; |
| | can be done by monitoring | Moderate risk - list of processes |
| | device's activities, e.g., using | can be extracted without admin |
| | ADB (Android Debug Bridge) | privileges on device only; or, |
| | connectivity. | Fall - list of processes can be |
| | | remotely extracted without |
| | | admin privileges. |
| Data leakage | Validate which parts of the | Pass - traffic is encrypted, and |
| | communication to/from the | no data leaks are detected; or, |
| | device are encrypted (and how) | Fail - traffic is unencrypted and |
| | or sent in clear text, and | sent in clear text, therefore data |
| | accordingly check if an | may leak from WIoT-DUT. |
| | application leaks data out of | |
| | device. | |
| Side-channel | Check for side-channel attack by | The criterion is measured by the |
| attacks | executing any desired measuring | level of correlation found |
| | tool (e.g., network traffic | between the events and |
| | monitoring, power consumption, | measurements (collected data); |
| | acoustic or RF emanations) and | the weaker the correlation, the |
| | analyze collected data while | higher the pass score. |
| | correlating it with specific events | |
| | performed by/using WIoT-DUT. | |
| Data collection | Check if an application on a | Safe - tested application does |
| | wearable IoT device collects | not collect and store data on |
| | sensor data and stores it on the | WIoT-DUT; |
| | device. This can be achieved by | Minor risk - tested application |
| | monitoring the locally stored data | collects and stores normal data, |
| | and correlating sensor events. | e.g., multimedia files, on WIoT- |
| | | DUT; |
| | | Major risk - tested application |
| | | collects and stores sensitive |
| | | data, e.g., GPS locations, on |
| | | WIoT-DUT; or, |
| | | Critical risk - tested application |
| | | collects and stores critical |
| | | information, e.g., device status |
| | | (CPU, memory, sensor events, |
| | | etc.), on WIoT-DUT. |
| Management | Attempt to access management | Pass - management access |
| access | interface/API of device using one | ports, e.g., port 22 (SSH), port |
| | of the communication channels. | 23 (Telnet), are closed; or, |
| | Access could be obtained by | Fail - one of the management |
| | using default credentials, a | access ports is open on tested |
| | dictionary attack, or other known | device. |
| | exploits. | |
| Breaking | Apply known/available | Pass - unable to decrypt traffic |
| encrypted traffic | techniques of breaking encrypted | sent/received by/to WIoT-DUT |
| | traffic. For example, try to | with applied techniques; or, |
| | redirect Hyper Text Transfer | Fail - able to decrypt traffic data |
| | Protocol Secure (HTTPS) to | sent/received by/to WIoT-DUT |
| | Hyper Text Transfer Protocol | using applied techniques. |
| | (HTTP) traffic (Secure Sockets | |
| | Layer (SSL) strip) or | |
| | impersonate remote servers with | |
| | self-certificates (to apply a man- | |
| | in-the-middle attack). | |
| Spoofing/ | Attempt to generate | Pass - reply attack failed; or, |
| masquerade | communication on behalf of | Fall - replay attack successful. |
| attack | tested wearable IoT device. For | |
| | example, determine if any of the | |
| | communication types can be | |
| | replayed to external server. | |
| Communication | Delay delivery of traffic between | Safe - time delay between two |
| delay attacks | device and remote server, | consecutive transactions of |
| | without changing its data | WIoT-DUT is within |
| | content. Determine which | defined/normal range; or, |
| | maximal delays are tolerated on | Unsafe - time delay is greater |
| | both ends. | than defined/normal range. |
| Communication | Attempt to selectively manipulate | Safe - device ignores received |
| tampering | or block data sent to/from device. | manipulated/erroneous data; or, |
| | For example, inject bit errors on | Unsafe - device crashes or |
| | different communication layers or | behaves unexpectedly when |
| | apply varying levels of noise on | manipulated/erroneous data is |
| | wireless channel. | sent. |
| List known | Given type, brand, version of | Safe - no relevant vulnerabilities |
| vulnerabilities | device, running services, and | were found; |
| | installed applications - list all | Minor risk - insignificant/low risk |
| | known vulnerabilities that could | vulnerabilities were found; or, |
| | be exploited. | Unsafe - significant and critical |
| | | vulnerabilities were found. |
| Vulnerability | Search for additional classes of | Safe - no new vulnerabilities |
| scan | vulnerabilities by: (1) utilizing | were found during testing |
| | existing tools (or developing new | process conducted; |
| | dedicated ones) that attempt to | Minor risk - insignificant/low risk |
| | detect undocumented | new vulnerabilities were found; |
| | vulnerabilities such as buffer | or, |
| | overflow and SQL injection; (2) | Unsafe - significant and critical |
| | maintaining a database of | new vulnerabilities were found. |
| | attacks (exploits) detected on | |
| | previously tested WIoTs or | |
| | detected by honeypots, and | |
| | evaluate relevant/selected | |
| | attacks on tested WIoT; and (3) | |
| | using automated tools for code | |
| | scanning. | |

The Advanced Security Testing Module (ASTM) 18 generates various environmental stimuli for each sensor/device under test. The Advanced Security Testing Module (ASTM) 18 is an operational module which simulates different environmental triggers, in order to identify and detect context-based attacks that may be launched by the WIoT-DUT. This is obtained using a simulator array list, such as a Global Positioning System (GPS) simulator or Wi-Fi localization simulator (for location-aware and geolocation-based attacks), time simulator (using simulated cellular network, GPS simulator, or local Network Time Protocol (NTP) server), movement simulator (e.g., using robots), etc. The Advanced Security Testing Module (ASTM) 18 interacts with the Measurements and Analysis Module (MAM) 20 in order to monitor and analyze the test performed. A list of simulators that may be supported by the Advanced Security Testing Module (ASTM) 18 is shown in Table 2 below.

TABLE 2

| Simulator | Description |
|---|---|
| Network | Testbed uses network simulators to simulate different network |
| | environments, such as Wi-Fi, Bluetooth, ZigBee, and more, in |
| | order to support different network connectivity in testbed. |
| Location | Testbed simulates different locations and trajectories using |
| | GPS generator device in order to test behavior of WIoT-DUT |
| | in different locations/trajectories. |
| Time | Testbed simulates different days of week and times of day |
| | using GPS generator device, internal NTP server or internal |
| | cellular network in order to test behavior of WIoT-DUT at |
| | different times. |
| Movement | Testbed simulates different movements using either robots or |
| | human testers in order to test behavior of WIoT-DUT while |
| | performing different movements. |
| Lighting | Testbed simulates different lighting levels in order to test |
| | behavior of WIoT-DUT in different lighting scenarios. |
| Audio | Testbed simulates audio using a voice simulator in order to |
| | test behavior of WIoT-DUT in different sound environments. |
| Video | Testbed simulates images, pictures, and videos using a video |
| | simulator in order to test behavior of WIoT-DUT during |
| | different video changes. |
| Pressure | Testbed simulates different levels of pressure in order to test |
| | behavior of WIoT-DUT under different pressure conditions. |

The Measurements and Analysis Module (MAM) 20 employs a variety of measurement (i.e., data collection) components and analysis components (both software and hardware-based). The measurement components include different network sniffers for communication monitoring such as Wi-Fi, cellular, Bluetooth, and ZigBee sniffers, and device monitoring tools for measuring the internal status of the devices under test. The analysis components process the collected data and evaluate the results according to a predefined success criterion (for example, binary pass/fail or a scale from 1-[pass] to 5-[fail]). The following is an example of a predefined success criterion: “if an SSH service is open on the tested device, and it is possible to access the device using a dictionary attack, then the test result is fail; if otherwise, the result is pass.” The predefined success criteria may not be generic and may be defined for a specific tested IoT device and/or tested scenario. For example, the success criterion of a data leakage test may be defined differently within the scope of private or enterprise usage scenarios of an IoT. In some cases, a success criterion may not be clearly defined, and therefore the analysis components may extract useful insights that may be investigated and interpreted by the system operator. As an example, a network-based anomaly detection component may be applied that processes the recorded network traffic of the tested WIoT and detects anomalous events in the system. In such a case, the pass/fail decision may be based on the number of detected anomalies and a predefined threshold provided by the system operator in advance. The detected anomalies may then be investigated and interpreted by the system operator using a dedicated exploration tool which is part of the user interface.

All the components of the data processing system or security testbed 10 may be implemented as a plugin framework to support future operational capabilities. The data processing system or security testbed 10 may be able to support most common types of wireless communication channels including Bluetooth, Wi-Fi, cellular network, ZigBee, radio-frequency identification (RFID) and near-field communication (NFC) connectivity, as well as wired communication technologies such as Ethernet and Universal Serial Bus (USB). The data processing system or security testbed 10 may also be able to process and analyze different communication protocols such as, for example, IPv4, IPv6, Transmission Control Protocol (TCP), User Datagram Protocol (UDP), Hypertext Transfer Protocol (HTTP), File Transfer Protocol (FTP) and Simple Network Management Protocol (SNMP), as well as security protocols such as Secure Sockets Layer (SSL), Transport Layer Security (TLS), Datagram Transport Layer Security (DTLS) and Internet Protocol Security (IPsec). The data processing system or security testbed 10 may be able to provide virtual machines to natively run software related to the wearable devices. In addition, the software tools of the data processing system or security testbed 10 may be able to support various embedded operating systems such as, for example, Android (Android Wear), Windows (Windows Mobile, Window 10 IoT), Linux and iOS.

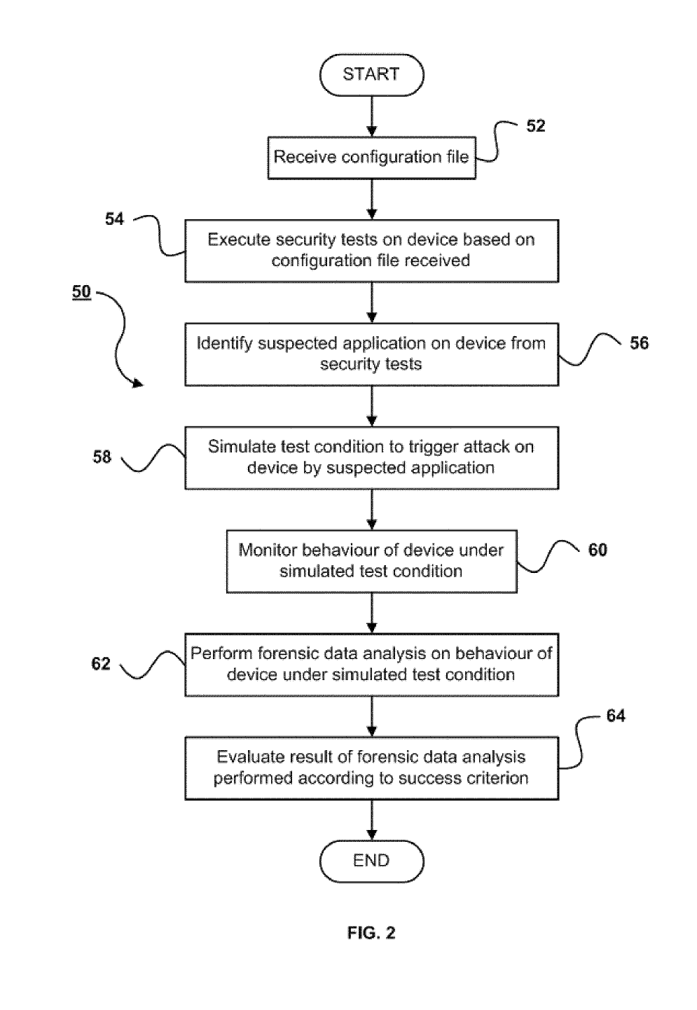

Having described the various elements of the functional architectural model of the data processing system or security testbed 10 for testing device security, a computer-implemented method for testing device security that may be performed by the data processing system or security testbed 10 will now be described below with reference to FIG. 2.

Referring now to FIG. 2, a computer-implemented method 50 for testing device security is shown. The computer-implemented method 50 begins at step 52 when a configuration file is received. The configuration file may be loaded in the security testbed 10 via the Management and Reports Module (MRM) 12.

Based on the configuration loaded, a standard security testing phase may be conducted using the Standard Security Testing Module (SSTM) 16 and a plurality of security tests is executed on a device at step 54 based on the configuration file received. The security tests may include one or more of a scanning test, a fingerprinting test, a process enumeration test, a data leakage test, a side-channel attack test, a data collection test, a management access test, a breaking encrypted traffic test, a spoofing attack test, a communication delay attack test, a communication tampering test, a known vulnerabilities enumeration test and a vulnerability scan test. The Device under Test (DUT) may be, for example, an activity tracker, a smartwatch, a pair of smart glasses, a piece of smart clothing, a pair of smart shoes or other smart healthcare device. Accordingly, the security testbed 10 may be able to examine a wide range of wearable devices from different categories.

At step 56, a suspected application on the device is identified from the security tests. This may involve identifying an irregular activity of the device during the security tests and/or comparing each of a plurality of applications installed on the device against an application whitelist and an application blacklist.

Using the results obtained in the standard security testing phase, a test condition is simulated at step 58 to trigger an attack on the device by the suspected application and a behaviour of the device under the simulated test condition is monitored at step 60. The step of monitoring the behaviour of the device may include monitoring an internal status of the device and/or monitoring communications with the device. This advanced security testing phase may be conducted using the Advanced Security Testing Module (ASTM) 18 and two (2) types of advanced security tests may be executed: context-based attacks and data attacks.

In the case of context-based attacks, an attacker designs an attack to be triggered when the device is within a specific state to enable a malicious function to evade detection. For detecting context-based attacks, the data processing system or security testbed 10 may realistically simulate environmental conditions using different simulators (e.g., sending different GPS locations and times) in order to trigger the internal sensor activities of the wearable IoT devices under test. By monitoring the behaviour of the tested device, the context in which different applications act may be identified. Accordingly, in such an embodiment, the test condition may include one or more environmental conditions. The one or more environmental conditions may include one or more of a network environment, a location, a trajectory, time, a movement, a lighting level, a sound environment, an image and pressure. In general, detecting context-based attacks requires executing a security test within different contexts. Due to the potentially large number of context variables (such as location, time, sound level, motion, etc.) and the infinite number of values for each contextual element, two (2) types of context-based tests may be defined: targeted and sample tests. In a targeted test, a bounded set of contexts to be evaluated by the testbed is provided as an input to the testing process. For example, an IoT device that is going to be deployed in a specific organizational environment is tested with the organization's specific geographical location, given the execution limits of the testbed. In a sample test, a subset of all possible contexts (those that can be simulated) is evaluated. The subset is selected randomly according to a priori assumptions about contexts of interest (for example, malicious activity is usually executed at night, the device is installed in a home environment).

Data attacks may be carried out by manipulating signals and data sent to sensors of the device. This class of attacks may result in manipulating the normal behaviour of the device (e.g., sending false GPS locations), performing a denial-of-service attack on the device by sending crafted data, or injecting code by exploiting vulnerabilities in the code that processes the sensor data. For detecting data attacks, the security testbed may support the execution of a set of predefined tests, each of which involves sending crafted sensor data, which includes specific edge cases or previously observed data attacks and monitoring the behaviour of the tested device. Accordingly, in such an embodiment, the step of simulating the test condition may include sending crafted data to the device and/or injecting code into the suspected application.

In the above described manner, the data processing system or security testbed 10 provides a range of security tests, each targeting a different security aspect. The standard security testing may be performed based on vulnerability scans and penetration test methodology in order to assess and verify the security level of the device under test, whilst the advanced security testing may be performed by the data processing system or security testbed 10 using different arrays of different types of simulators (e.g., a GPS simulator that simulates different locations and trajectories, movement simulators such as robotic hands, etc.) to realistically generate arbitrary real-time simulations, preferably for all sensors of the tested device. The security testbed may also be able to emulate different types of testing environments such as indoor and outdoor, static and dynamic environments, as well as mobile scenarios. The standard and advanced security testing phases may be controlled by the Security Testing Manager Module (STMM) 14. The data processing system or security testbed 10 may also be able to support user intervention and automation capabilities during all phases of the test sequence.

At step 62, a forensic data analysis is performed on the behaviour of the device under the simulated test condition by the Management and Reports Module (MRM) 12 based on the results obtained from both the standard and advanced security testing phases. To perform the security forensic data analysis, the data processing system or security testbed 10 extracts all stored data from the tested device including system snapshots (the status of the memory and processes) and system files (e.g., configuration files). Data extraction may be achieved through connections such as Universal Serial Bus (USB) and Joint Test Action Group (JTAG) by using different command line tools such as Android Debug Bridge (ADB).

A result of the forensic data analysis performed may be evaluated at step 64 according to a success criterion. The step of evaluating the result of the forensic data analysis performed may include calculating a probability of the attack and may further include calculating a severity of the attack.

The data processing system or security testbed 10 may include management and report mechanisms to control and manage the testing flow, as well as to generate reports upon completion. Such report tools may include intelligent data exploration tools for manual investigation and analysis of the collected and processed data. In addition, information obtained from the security tests, as well as prior settings provided by the system operator, may be used to output the probability of an attack and its severity of impact, and consequently this may also be used to quantify risks associated with using the tested WIoT in different case scenarios.

The data processing system or security testbed 10 is thus able to test the wearable IoT device's security against a set of security requirements including discovery, vulnerability scans, and penetration tests, as well as the device behavior under various conditions (e.g., when different applications are running). The data processing system or security testbed 10 is designed to simulate environmental conditions in which the tested device might be operated, such as the location, time, lighting, movement, etc., in order to detect possible context-based attacks (i.e., attacks that are designed to be triggered when the device is within a specific state) and data attacks that may be achieved by sensor manipulation.

The data processing system 10 may include one or more processors configured to perform or execute the steps of the computer-implemented method 50 for testing device security.

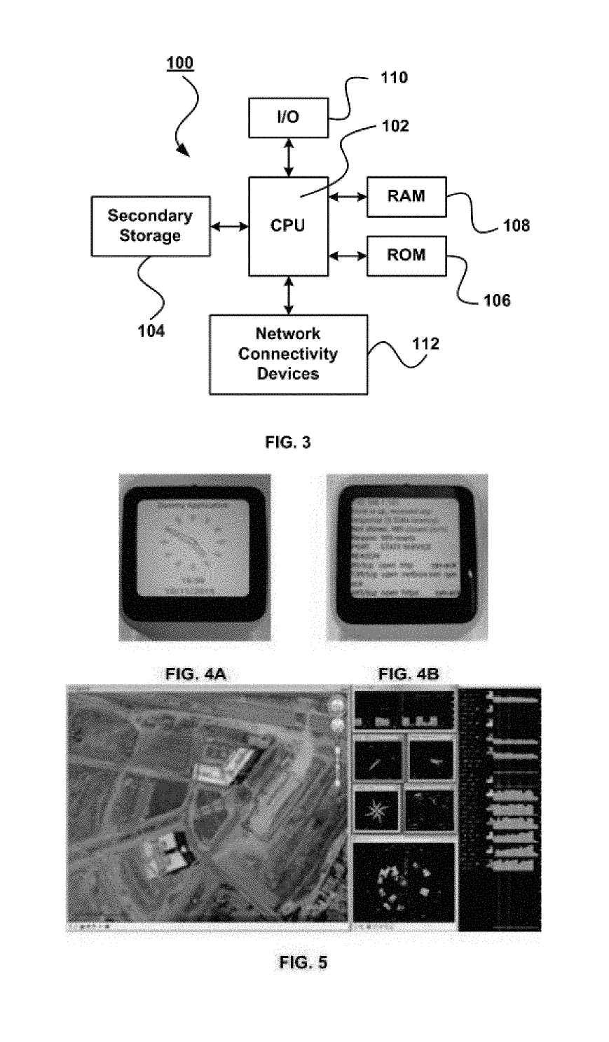

Referring now to FIG. 3, a computer system 100 suitable for implementing the data processing system 10 and the computer-implemented method 50 for testing device security is shown. The computer system 100 includes a processor 102 (which may be referred to as a central processor unit or CPU) that is in communication with memory devices including secondary storage 104, read only memory (ROM) 106, random access memory (RAM) 108, input/output (I/O) devices 110, and network connectivity devices 112. The processor 102 may be implemented as one or more CPU chips.

It is understood that by programming and/or loading executable instructions onto the computer system 100, at least one of the CPU 102, the RAM 108, and the ROM 106 are changed, transforming the computer system 100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 100 is turned on or booted, the CPU 102 may execute a computer program or application. For example, the CPU 102 may execute software or firmware stored in the ROM 106 or stored in the RAM 108. In some cases, on boot and/or when the application is initiated, the CPU 102 may copy the application or portions of the application from the secondary storage 104 to the RAM 108 or to memory space within the CPU 102 itself, and the CPU 102 may then execute instructions that the application is comprised of. In some cases, the CPU 102 may copy the application or portions of the application from memory accessed via the network connectivity devices 112 or via the I/O devices 110 to the RAM 108 or to memory space within the CPU 102, and the CPU 102 may then execute instructions that the application is comprised of. During execution, an application may load instructions into the CPU 102, for example load some of the instructions of the application into a cache of the CPU 102. In some contexts, an application that is executed may be said to configure the CPU 102 to do something, e.g., to configure the CPU 102 to perform the function or functions promoted by the subject application. When the CPU 102 is configured in this way by the application, the CPU 102 becomes a specific purpose computer or a specific purpose machine.

The secondary storage 104 is typically comprised of one or more disk drives or tape drives and is used for non-volatile storage of data and as an over-flow data storage device if RAM 108 is not large enough to hold all working data. Secondary storage 104 may be used to store programs which are loaded into RAM 108 when such programs are selected for execution. The ROM 106 is used to store instructions and perhaps data which are read during program execution. ROM 106 is a non-volatile memory device which typically has a small memory capacity relative to the larger memory capacity of secondary storage 104. The RAM 108 is used to store volatile data and perhaps to store instructions. Access to both ROM 106 and RAM 108 is typically faster than to secondary storage 104. The secondary storage 104, the RAM 108, and/or the ROM 106 may be referred to in some contexts as computer readable storage media and/or non-transitory computer readable media.

I/O devices 110 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 112 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the above-described method steps. Such information, which is often represented as a sequence of instructions to be executed using processor 102, may be received from and outputted to the network, for example, in the form of a computer data signal embodied in a carrier wave.

Such information, which may include data or instructions to be executed using processor 102 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 104, for example, hard drives, floppy disks, optical disks, and/or other device, the ROM 106, and/or the RAM 108 may be referred to in some contexts as non-transitory instructions and/or non-transitory information.

In an embodiment, the computer system 100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 100 to provide the functionality of a number of servers that is not directly bound to the number of computers in the computer system 100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 100, at least portions of the contents of the computer program product to the secondary storage 104, to the ROM 106, to the RAM 108, and/or to other non-volatile memory and volatile memory of the computer system 100. The processor 102 may process the executable instructions and/or data structures in part by directly accessing the computer program product, for example by reading from a CD-ROM disk inserted into a disk drive peripheral of the computer system 100. Alternatively, the processor 102 may process the executable instructions and/or data structures by remotely accessing the computer program product, for example by downloading the executable instructions and/or data structures from a remote server through the network connectivity devices 112. The computer program product may comprise instructions that promote the loading and/or copying of data, data structures, files, and/or executable instructions to the secondary storage 104, to the ROM 106, to the RAM 108, and/or to other non-volatile memory and volatile memory of the computer system 100.

In some contexts, the secondary storage 104, the ROM 106, and the RAM 108 may be referred to as a non-transitory computer readable medium or a computer readable storage media. A dynamic RAM embodiment of the RAM 108, likewise, may be referred to as a non-transitory computer readable medium in that while the dynamic RAM receives electrical power and is operated in accordance with its design, for example during a period of time during which the computer system 100 is turned on and operational, the dynamic RAM stores information that is written to it. Similarly, the processor 102 may comprise an internal RAM, an internal ROM, a cache memory, and/or other internal non-transitory storage blocks, sections, or components that may be referred to in some contexts as non-transitory computer readable media or computer readable storage media.

### EXAMPLE

An exemplary testbed employing an exemplary computer-implemented method for testing device security will now be described below.

An isolated Wi-Fi network was built in order to simulate a small organizational environment. During the experiment, a network simulator (using a Wi-Fi router) and a GPS simulator (LabSat 3 device) were used as part of the simulator array in the testbed framework. In addition, different measurement and analysis tools were used including a sniffer device based on the Wireshark network protocol analyzer tool [Wireshark] that monitored the communication traffic during the test. A tester device that ran dedicated scripts which recorded the internal status data of the WIoT-DUTs during the test (via ADB connectivity) was also employed. The tester device was also used for executing the standard security tests. The testbed was equipped with an internal IP camera that documented and recorded the course of a test, as well as an external workstation that was used to control the testbed's operation, including defining, executing, and analyzing tests. A Wi-Fi printer was used as an environmental component in the testbed.

Selected wearable devices (WIoT-DUTs), specifically, a Google Glass device, a Sony smartwatch 3 SWR50 and a S8 Smart Watch Phone, were tested.

The wearable devices were tested within a shielded room which provided a neutral security testbed environment for conducting various tests, such as simulating Global Positioning System (GPS) locations, with minimal external disruptions.

The experiment was conducted in two phases. Firstly, as part of the standard security testing phase (using the SSTM component), a preliminary security analysis was conducted for all of the wearable IoT devices under test (WIoT-DUTs). Then, based on the information collected and analyzed, a context-based security testing process was executed by the ASTM. This was done by using a GPS simulator that simulated different locations and times of day as the triggers for context-based attacks that were carried out by malicious applications installed on the smartwatch devices. Finally, forensic analysis was performed in order to detect the context-based attacks in the testbed.

Two (2) malicious applications were specifically implemented in order to illustrate the operation of the testbed, one for each smartwatch device. These “malicious” applications read the time from the watch and the GPS raw data directly from the internal built-in GPS sensor of the smartwatch devices. This information was then used for time-based and location-based attacks, respectively. In other words, time and location were the contextual triggers for the attacks implemented. These applications may be any legitimate applications that currently exist for smartwatch devices (such as a fitness application that uses the GPS connectivity), but once the conditions are met (time of day, location identification, and/or Wi-Fi connectivity), the applications covertly execute a context-based attack. For example, the application implemented and installed on the Sony smartwatch device performed a network mapping attack once the location was identified by the application and the Wi-Fi connectivity was enabled in the device. The network mapping attack was implemented by utilizing the Nmap tool that was modified to run in an Android Wear environment (this was done by adjusting and enhancing an open source code [PIPS]). In this case, Nmap was used as an attack tool that required only a standard mode of operation, without the need for a rooted device. The information received during the attack included all IP addresses and open TCP/UDP ports for each IP address, for all hosts (wireless-based) connected to the Wi-Fi network, as shown in FIG. 4.

The second “malicious” application that was implemented was installed on the ZGPAX S8 Smart Watch Phone device. This application executed a fake access point (AP) attack based on the time of day as the trigger. In this case, the ZGPAX device posed as a legitimate AP in the network in order to “silently” collect sensitive information from the organization. That is, first, the smartwatch phone device was connected directly to the Wi-Fi's organizational network as a legitimate client. Then, once the specific hour of the day that the attacker set in advance was identified, the application opened a malicious AP with the same SSID name of another legitimate AP in the network, in this case a Wi-Fi printer.

In the security testing process, a preliminary security analysis for the Google Glass device, the Sony smartwatch, and the ZGPAX smartwatch device were first executed. As part of the Standard Security Testing Module (SSTM), the following subset of security tests from Table I was implemented: Scanning, Fingerprinting, Process Enumeration, Data Collection, and Management Access. Different security testing tools available online such as the Nmap security scanner tool [Nmap], the Kali Linux penetration testing environment [Kali], and several scripting tools were utilized for this testing phase. Using these generic tools, the WIoT-DUTs were investigated from different aspects including: the operating system, communication channels, firmware and hardware (sensor point of view), and the applications installed in the device. All the tests were conducted using the tester device and using the Kali Linux platform.

Firstly, in order to identify the WIoT-DUTs in the testbed and for analysing the information exposed by the WIoT-DUTs via different communication channels, a scanning test was implemented. During this test, all WIoT-DUTs in the testbed were detected both via scanning the wireless communication channel (by scanning the Wi-Fi network using an ‘arping’ command) and via scanning wired connectivity (by scanning all USB ports of the tester device and detecting the ADB connectivity of all of the devices under test. For that, the developer mode was enabled in all of the devices. This means that the WIoT-DUTs were accessible in the testbed for further analysis both via wireless and wired communication channels.

Next, the fingerprinting test was run for each WIoT-DUT separately in order to identify the properties of the device such as its type (type of wearable device), the OS installed, software versions, open ports (TCP/UDP), communication channels supported by the device and their configurations, device memory, a list of features and device capabilities (such as a set of sensors supported by the device), etc. The Nmap tool (for wireless communication) was used and a dedicated script (that executes different commands, such as ‘getprop,’ ‘pm list features,’ etc.) was also run via the ADB connectivity in order to collect the information needed for the fingerprinting test.

For the process enumeration test, a script (that uses the ‘top’ and ‘pm list packages’ commands via ADB shell) was executed in order to list all of the processes running and application packages installed on the WIoT-DUTs, as well as to monitor their CPU and memory consumptions. Using the above information, the devices' activities were further analysed.

During the data collection test, the internal device monitoring tools were employed. Using these tools, the WIoT-DUTs' activities (from memory, CPU, file system perspectives, and more) were investigated, while running the applications installed on these WIoT-DUTs. Further information was also extracted for each application such as its permissions (using ‘clumpsys package’ command), etc. Based on this examination, selected applications were tagged as suspicious applications (e.g., applications that use the GPS while running) that were later tested by the ASTM component.

In the management access security test, both telnet and SSH connections were tested in order to examine whether these services were opened unexpectedly and/or accessible. In this test, an attempt was made to connect to the WIoT-DUTs via these connections using a dictionary attack methodology. Common usernames (such as ‘root,’ ‘admin,’ etc.) and a common password list (by utilizing the well-known password list ‘rockyou.txt’ database) were used for this test. In all cases, both telnet and SSH connections were found to be closed. Although the list of all of the WIoT-DUTs' open ports could be examined, it was decided to actively perform the security connectivity test and try to connect to the WIoT-DUTs via these connections (telnet and SSH) in order to illustrate the testbed capabilities.

All of the results obtained during this phase, including the list of all suspicious applications mentioned above, were stored in the system database. In this case, the list of suspicious applications included the malicious applications that were specifically implemented. This list was then used as input for the context-based security testing phase in the testing process. The above list of suspicious applications may be generated by either the testing process itself (by identifying abnormal behavior during the test, e.g., GPS activated unexpectedly, etc.) or by examining each application installed in the device against whitelisted and blacklisted application databases available online (e.g., based on application ratings, etc.).

In order to determine whether the devices under test were compromised by malicious applications, a context-based security testing phase was next executed. In this phase, both the smartwatch devices were further tested by examining the suspected applications from the list generated in the previous phase. For this, a GPS simulator device (LabSat 3) was used in order to realistically simulate the environmental conditions (i.e., locations and times) that would trigger the internal sensor activities of the tested smartwatch devices, and would accordingly trigger the attacks discussed above. Therefore, prior to performing the test, a predetermined path was recorded around campus that was later replayed during the testing process in order to illustrate changes in space and time for the attacks. The overall testing time (˜10 minutes) of the advanced/dynamic security testing phase performed in the experiment is defined based on the recorded path shown in FIG. 5.

For the context-based security testing, an isolated Wi-Fi network was established and the WIoT-DUTs (the Sony and ZGPAX smartwatch devices) were connected to the tester device. For each WIoT-DUT, an ADB connection was opened in the tester computer in order to monitor and track the device's internal activities during the testing process. Several measurement and analysis tools using scripts that read and locally store (on the tester device) the internal state of the WIoT-DUTs at the beginning, during, and at the end of the test were employed. The recording includes the memory and CPU consumption, the file system configuration, the space usage (used for temporal file tracking), a list of active processes in the WIoT-DUT, a list of SSIDs available in the network, and the time and location received by the GPS simulator (which will be used in the forensic analysis procedure to identify the time and locations of the attacks). These parameters were recorded as changes in the internal state of the WIoT-DUTs were expected to be seen at the time of the attacks. In addition, a Sniffer device from the measurement and analysis tools was used in order to monitor and track communication changes during the testing process. Here as well, changes in the communication were expected to be seen at the time of the attacks.

At the beginning of the test, the “malicious” applications (the suspicious applications) were started and the scripts from the tester device were ran for each of the smartwatch devices under test (via the ADB connections) in order to record their internal state data during the testing process. Once the initial data collection was complete, both the GPS simulator and the Wireshark application were started simultaneously. This was done in order to synchronize the time of the recorded path and the network traffic monitoring. This point is defined as the starting point, T0, of the test. In this phase, the recorded path was replayed in the testbed by the GPS simulator in order to illustrate changes in space (locations) and time. Accordingly, once the locations and times for the context-based attacks defined above were identified by the WIoT-DUTs, the attacks were executed in the testbed. Controlled false alarms were also injected during this period (by executing a port scan with the laptop on one of the devices which is not one of the WIoT-DUTs). This was done to demonstrate the forensic analysis for these events such that the testbed should be able to handle this type of situation as a comprehensive security testing system. Finally, once the replay of the recorded path by the GPS simulator was finished (after ˜10 minutes) and defined as the ending point, Tn, of the test, the test was stopped (stopped the traffic monitoring and automatic scripting) and the test results (communication monitoring and WIoT-DUT internal state data that were recorded during the test) were stored in the testbed system database, and the overall test was completed.

In order to identify the context-based attacks in the testbed, a forensic analysis was performed for each smartwatch device tested based on the recorded information (communication and internal status of the DUTs) obtained during the testing process discussed above. This was done by examining both the suspicious behavior of the tested devices based on memory consumption and CPU utilization, and the communication transmissions recorded during the test. The locations and times for the attacks discussed above were randomly selected from the recorded path, meaning in each new execution of the dummy applications, different locations and times were selected for the context-based attacks. Accordingly, forensic analysis was performed manually and individually on findings obtained for each new test executed in the testbed, utilizing the testing methodology presented below.

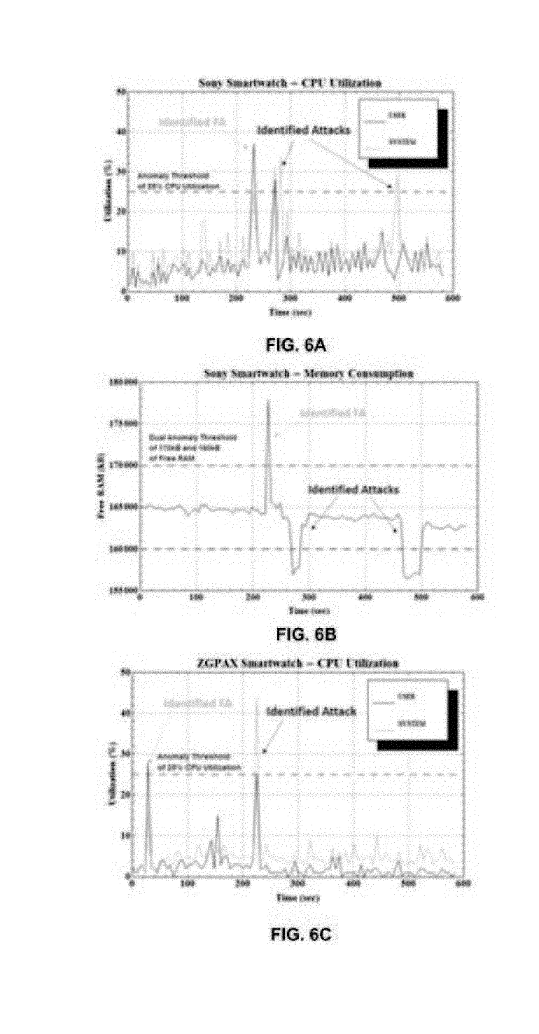

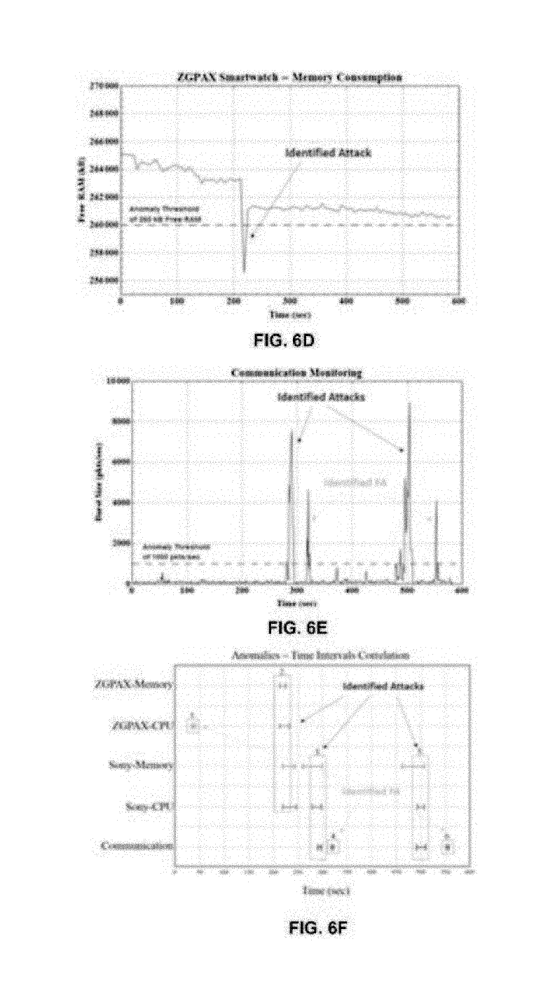

Referring now to FIGS. 6A through 6F, the internal status of the Sony smartwatch and the ZGPAX smartwatch devices from both CPU utilization (user and system perspectives in percentages) and memory consumption (from the free RAM point of view in kB) that were recorded during the test with respect to the testing time (in seconds) are shown in FIGS. 6A through 6D. Regarding the free RAM parameter, it should be noted that when the application starts to run, the system memory decreases, as is shown in the respective graphs. The communication activity obtained during the test performed, in terms of packets per second (axis Y), with respect to the testing time in seconds (axis X) is shown in FIG. 6E. The graph was generated using the information extracted from the 10 Graph tool (Wireshark). Finally, FIG. 6F shows the correlation in the time dimension between all of the events/anomalies that occurred during the testing process.

Note that the emphasis here is on anomalies and not on the actual attacks that were executed as it is not known when the attacks occurred and the testbed should be able to deal with false alarm events. After the post-mortem procedure, a decision may be made as to which of the anomalies were attacks and which were false alarm events. Each anomaly was manually analyzed in order to understand its origin (the source of the deviation in the graph) and to find any correlation between the anomalies that occurred during the test.

During the entire forensic analysis process presented here, the focus was on the major deviations that showed significant changes in the graphs. For the CPU analysis, an anomaly is defined as high CPU utilization, and from the memory perspective, an anomaly is defined as high memory consumption/releasing. For the communication analysis, an anomaly is defined as a burst of transmissions with high traffic volume. An anomaly threshold that was determined based on the results obtained was employed in order to define the anomalies for each parameter (communication, CPU, and memory).

From the perspective of the Sony smartwatch device shown in FIGS. 6A and 6B, it can be seen that there were three (3) major anomalies that occurred in both the CPU utilization (FIG. 6A) and the memory consumption (FIG. 6B), which were defined by the selected thresholds. Note that in the memory graph, a dual threshold was used for the analysis. The time intervals for all the anomalies obtained were then defined. From the CPU point of view, the time intervals were as follows: the first anomaly was between 217 seconds and 248 seconds, the second was between 260 seconds and 299 seconds, and the third anomaly was between 485 seconds and 507 seconds. From the free RAM point of view, the time intervals of the anomalies were: 217-243 seconds, 260-300 seconds, and 463-507 seconds.

From the ZGPAX smartwatch-phone device analysis perspective shown in FIGS. 6C and 6D, it can be seen that there are two (2) major anomalies in the CPU utilization graph (FIG. 6C) and only one (1) anomaly in the memory consumption graph (FIG. 6D), both of which were defined by the selected thresholds. The time intervals for the anomalies in the CPU graphs are between 34 seconds and 40 seconds and 212 seconds to 231 seconds, and the anomaly shown in the memory graph is in the time interval of 212-225 seconds.

The communication monitoring that was recorded during the testing process for one of the tests performed was also examined. For this, the pcap file (generated by Wireshark) and the list of all available SSIDs in the network (recorded using the scripts developed) were manually analyzed. As can be seen in FIG. 6E, four (4) anomalies/deviations are shown in the graph with respect to a threshold of 1000 packets per second. Using this threshold, the time intervals in which the anomalies occurred was defined. In this case, the first anomaly is defined as the time interval between 280 seconds and 294 seconds, the second is 318-323 seconds, the third is 479-510 seconds, and the fourth anomaly is defined as the time interval between 551 seconds and 556 seconds.

After defining the time intervals for all anomalies that occurred during the test (based on the analysis shown above), a correlation between these anomalies is found in order to identify and detect the context-based attacks executed in the testbed. FIG. 6F shows the correlation in the time dimension between all the anomalies that occurred (denoted by points 1 to 6 in the graph). As can be seen from points 3 and 5 in FIG. 6F, there is an indication of a correlation between the anomalies that occurred in the CPU and memory parameters of the Sony smartwatch device and the anomalies that occurred in the communication space at these points of the test in that at that time during the test, the Sony device performs some activity which influences the network. These time intervals were therefore further investigated and the network traces from the pcap file were analyzed at these indications of anomaly.

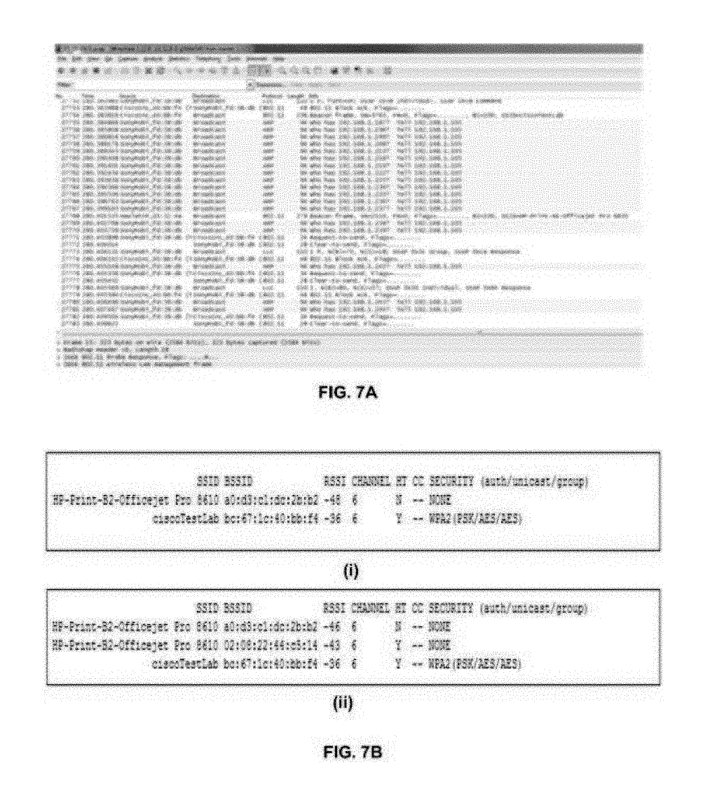

Referring now to FIG. 7A, network traces in the pcap file of one of the anomalies defined during the forensic analysis for the Sony device are shown. From the analysis, it was found that the Sony smartwatch device executed some sort of network scanning at that time during the test as illustrated in FIG. 7A. Therefore, it was observed that two (2) network mapping attacks were executed by the Sony smartwatch device at these points during the test.

As part of the information collected during the test (using the dedicated scripts), the locations and times (the replayed information) that the GPS simulator transmits in the testbed were also recorded. Accordingly, from the above analysis, the specific locations and times that the network mapping attacks were executed by the Sony smartwatch device in the testbed (with respect to geo-fencing and time frame parameters of 50 meters and two minutes, respectively) can now be obtained as follows: the first attack occurred on 08-11-2015, 12:17:06 (this is the actual date and time of the path recorded prior to the test) at location: latitude=31.26445, longitude=34.8128716, and the second attack occurred on 08-11-2015, 12:20:22 at location: latitude=31.26309, longitude=34.8116266.

Referring again to FIG. 6F, it can be see that there is no anomaly in the communication space at point 2 of the test. However, there is a correlation between the anomalies caused by the Sony device and those that were caused by the ZGPAX device (from both the CPU and memory parameters) at that point. This means that one of the devices, either the Sony or ZGPAX device, performed some activity in the testbed that may have affected the other device (such that the anomalies of the affected device can be explained as internal memory management and CPU processing of that device due to this activity). To understand the origin of these anomalies, the SSID list (the list of all Wi-Fi networks around the test area) that was recorded during the test were further examined and analyzed.

Referring now to FIG. 7B, an illustration of a fake access point (AP) attack in the testbed environment is shown. More particularly, FIG. 7B(i) shows the SSID list before the attack was executed, whilst FIG. 7B(ii) shows that at the point of the attack, a new AP with the same SSID name as the Wi-Fi printer was added to the network (with the BSSID name of the ZGPAX smartwatch-phone device). Accordingly, the examination indicated that at point 2 of the test (see point 2 in FIG. 6F), another access point had been added to the list with the same SSID name as one that already existed in the network. As shown in FIG. 7B(ii), the new/fake SSID name added was HP-Print-B2-Officejet Pro 8610, with a different BSSID name (MAC address 02:08:22:44:C5:14) than the actual printer. This BSSID name is related to the ZGPAX smartwatch-phone device (belonging to the fake AP that opened in the smartwatch device due to the attack). Accordingly, this demonstrates that the fake access point attack (fake Wi-Fi printer attack) that was executed by the ZGPAX smartwatch-phone device during the test can be detected by the testbed. As before, the specific location and time of the fake access point attack (again, with respect to the geo-fencing and time frame parameters) was determined to be as follows: 08-11-2015, 12:15:46 at location: latitude=31.2644366, longitude=34.8119433.

Other anomalies that occurred during the testing process are denoted by points 1, 4 and 6 in FIG. 6F. Point 1 refers to the anomaly that occurred in the CPU utilization of the ZGPAX device. At that point in time, the test had only begun. Therefore, this anomaly could be explained as internal CPU processing performed due to the synchronization of the ZGPAX smartwatch-phone device with the GPS signal. Note that at the beginning of each new test, the WIoT-DUTs had to resynchronize with the GPS signal transmitted in the testbed. In regard to points 4 and 6 in FIG. 6F, these referred to anomalies that occurred in the communication space. There is no correlation between these anomalies and the anomalies of the DUTs. As only the Sony smartwatch and the ZGPAX smartwatch-phone devices were actively tested in the testbed during the second phase of the testing process, only these devices and the GPS simulator device were active in the testbed. These anomalies may therefore be considered false alarms that were not caused by the WIoT-DUTs. Recall that during the execution of the test, two controlled false alarms were actually injected by executing a port scan with the laptop on one of the devices in the network which was not a WIoT-DUT. Accordingly, further examination of the network traces in the pcap file during the time intervals of these anomalies showed that these were actually port scan events. Hence, these anomalies were identified to be the injected false alarms in the final forensic analysis procedure.

The final reports for the full testing process presented above may be generated by the Management and Reports Module (MRM). The results may be stored in the system database component and sent to the user.

The experiment demonstrated that the testbed may be operated as a complete testing system, providing a generic security testing platform for wearable IoT devices regardless of the type of device under test, its hardware (sensors, etc.) and software (OS) configurations and user applications installed on the device. The experiment also demonstrated the robustness of the testbed and its ability to withstand real context-based attacks that may be carried out by compromised wearable IoT devices. The proposed security testbed may therefore serve as a new tool for measuring and analyzing the security of wearable IoT devices in different case scenarios.

As is evident from the foregoing discussion, the present invention provides a computer-implemented method and a data processing system for testing device security, in particular, the security level of Internet of Things (IoT) devices. Advantageously, the advanced security analysis mechanism of the present invention: (1) performs security testing for devices (running known applications) as a means of assessing their security level, and (2) executes security testing for devices that are suspected of having been compromised by malicious applications. Further advantageously, as the conditions that trigger malicious applications to execute attacks are not always known, the advanced security analysis mechanism of the present invention is also able to simulate possible conditions (e.g., using different simulators) in order to identify any context-based attacks a device may carry out under predefined conditions that an attacker may set, as well as data attacks which may be achieved by sending crafted (or manipulated) context/sensor data. The advanced security analysis mechanism of the present invention is able to simulate environmental conditions in which the tested device might be operated such as the location, time, lighting, movement, etc. Using the advanced security analysis mechanism of the present invention, a dynamic analysis may be performed by realistically simulating environmental conditions in which WIoT devices operate. Further advantageously, the advanced security analysis mechanism of the present invention is able to execute relevant security tests with minimal human intervention.

While preferred embodiments of the invention has been illustrated and described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A computer-implemented method for testing device security, comprising executing on one or more processors the steps of:
receiving a configuration file;
executing a plurality of security tests on a device based on the configuration file received;
identifying a suspected application on the device from the security tests;
simulating a test condition to trigger an attack on the device by the suspected application;
monitoring a behaviour of the device under the simulated test condition; and
performing a forensic data analysis on the behaviour of the device under the simulated test condition.

2. The computer-implemented method for testing device security according to claim 1, wherein the test condition comprises one or more environmental conditions.

3. The computer-implemented method for testing device security according to claim 2, wherein the one or more environmental conditions comprise one or more of a network environment, a location, a trajectory, time, a movement, a lighting level, a sound environment, an image and pressure.

4. The computer-implemented method for testing device security according to claim 1, wherein the step of simulating the test condition comprises sending crafted data to the device.

5. The computer-implemented method for testing device security according to claim 1, wherein the step of simulating the test condition comprises injecting code into the suspected application.

6. The computer-implemented method for testing device security according to claim 1, wherein the security tests comprise one or more of a scanning test, a fingerprinting test, a process enumeration test, a data leakage test, a side-channel attack test, a data collection test, a management access test, a breaking encrypted traffic test, a spoofing attack test, a communication delay attack test, a communication tampering test, a known vulnerabilities enumeration test and a vulnerability scan test.

7. The computer-implemented method for testing device security according to claim 1, wherein the step of identifying the suspected application on the device comprises identifying an irregular activity of the device during the security tests.

8. The computer-implemented method for testing device security according to claim 1, wherein the step of identifying the suspected application on the device comprises comparing each of a plurality of applications installed on the device against an application whitelist and an application blacklist.

9. The computer-implemented method for testing device security according to claim 1, wherein the step of monitoring the behaviour of the device comprises monitoring an internal status of the device.

10. The computer-implemented method for testing device security according to claim 1, wherein the step of monitoring the behaviour of the device comprises monitoring communications with the device.

11. The computer-implemented method for testing device security according to claim 1, further comprising:
evaluating a result of the forensic data analysis performed according to a success criterion.

12. The computer-implemented method for testing device security according to claim 11, wherein the step of evaluating the result of the forensic data analysis performed comprises calculating a probability of the attack.

13. The computer-implemented method for testing device security according to claim 12, wherein the step of evaluating the result of the forensic data analysis performed further comprises calculating a severity of the attack.

14. A data processing system for testing device security comprising one or more processors configured to perform the steps of the computer-implemented method according to claim 1.
